(19) United States
(12) Patent Application Publication
(10) Pub. No.: US 2021/0118331 A1
(43) Pub. Date: Apr. 22, 2021

(54) Topographical Globe and Its Associated Method of Manufacture

(71) Applicant: Ugo (US) LLC, Ashland, OH (US)

(72) Inventors: Donglin ZHAO, Shenzhen (CN); Rongliang ZHANG, Shanghai (CN)

(21) Appl. No.: 16/656,563

(22) Filed: Oct. 17, 2019

(51) Int. Cl. G09B 27/08; B32B 37/12; B32B 38/00; B32B 27/08; B29C 51/10; B29C 51/14; B29C 51/26; B29C 45/14; B29C 65/00

(52) U.S. Cl. CPC G09B 27/08; B32B 37/12; B32B 38/145; B32B 27/08; B29L 2022/002; B29C 51/14; B29C 51/266; B29C 45/14336; B29C 66/543; B29C 51/10

(57) ABSTRACT

A globe assembly and method of manufacturing a raised relief globe including laminating the at least two plastic layer sheets as the printing sheet. The plastic sheet has the longitude and transverse. Both the two layers can have the same longitudinal strength and transverse strength. When laminating, maintain the longitude of first layer same direction as the transverse of second layer, so the transverse of the first layer has the same direction as the longitude of the second layer. A map design is then printed on the flat laminating plastic sheet. The plastic sheet is formed into a substantially hemispherical shape. A mold core is positioned on the back side of the sheet. A styrene backing is molded onto the hemispherical shaped sheet. A second molded hemisphere is produced in the substantially the same manner. The two hemispheres are then assembled as the raised relief globe.

### BACKGROUND OF THE INVENTION

### 1. Field of the Invention

In general, the present invention relates to globes and to the methods of manufacturing globes. More particularly, the present invention relates to the manufacture of topographic globes that have either a smooth surface and/or raised surface features.

### 2. Prior Art Description

Globe maps have been in existence for centuries. A globe map depicts the continents, oceans and often countries of the world on a sphere that represents the earth. Traditionally, globes are made by printing a map on paper. The paper is then cut to fit the shape of a sphere and is glued onto the surface of the sphere to produce a globe. To add interest to a globe, topographical features, such as raised mountain ranges can be added to the globe. This is traditionally created by placing material, such as paper mâché, onto the sphere before the printed map is glued to the sphere. However, accurately adding topographical features to a globe in this manner is highly labor intensive. As such, it adds significantly to the time and cost of producing a globe.

Using more modern printing techniques, topographic globes have been produced in a more automated fashion. For instance, in U.S. Pat. No. 4,300,887 to Riemer, a topographic globe is made by printing features onto a vinyl plastic sheet. The printed vinyl plastic sheet is then placed inside an injection mold. Using the injection mold, a shaped sphere is molded behind the plastic sheet. The formation of the sphere heats and warps the vinyl plastic sheet as molten plastic is injected. The melted and warped vinyl plastic sheet forms the exterior of the globe and provides the globe with raised surface features. However, there are many problems associated with this prior art fabrication technique. One major problem is that each printed sheet of vinyl melts and deforms slightly differently when placed inside an injection mold. As a consequence, different features printed on the vinyl warp differently on a sheet-by-sheet basis. As a consequence, precision cannot be obtained and the graphics printed on the vinyl sheet do not always align with the topographical features embodied on the globe. For example, the printing position of the top of a mountain may not align physically with the top of the mountain on the globe. Furthermore, some of the graphics printed on the vinyl sheet can appear hard to read due to the uneven melting and warping. If a globe is formed by joining two hemispheres, as is often the case, then the two hemispheres are joined after the injection molding process. Due to the variations in how the printed vinyl sheets melt and deform, the printed features on one hemisphere may not align properly with the printed features on the opposite hemisphere. As a consequence, after the two hemispheres are joined into a globe, the globe must be corrected, scrapped, or sold as low quality.

A need therefore exists in the art of making topographical globes that enable a high-quality globe to be quickly and economically produced. This need is met by the present invention as described and claimed below.

### SUMMARY OF THE INVENTION

The present invention is a globe assembly and the associated method of manufacturing the globe assembly. The globe assembly has an exterior casing that is made from laminated layers of plastic sheeting. The plastic sheeting, whether produced by calendaring or by an extrusion calendaring process, has significant different properties in the longitude and transverse directions. Such properties include tensile strength and heating extensile rate. When flat laminated layers of printed plastic sheet are reformed as a hemisphere in a spherical shaped mold, the thickness of plastic hemisphere varies at different points. The position of the printing pattern is unfixed unless the layers are bonded. Unfixed layers become further problematic during later injection molding processes.

To prevent such problems, at least two plastic layer sheets are laminated as the printing sheet; The plastic layers have longitude and transverse directions. When laminating, the longitude direction of the first plastic sheet is aligned with the longitude direction of the second layer sheet.

A map is printed on the flat laminating plastic sheet. The laminated sheet is then vacuum formed into a substantially hemispherical shape. A mold core is positioned on the back side of the hemispherical shape. A styrene backing is injection molded to the hemispherical shaped sheet to conform the sheet with the mold cavity. This includes relief areas defined in the cavity wall and removing the molded hemisphere from the mold. A second molded hemisphere is produced in the substantially the same manner. The two hemispheres are assembled as the raised relief globe.

Topographical features can be formed on the exterior casing if desired by the manufacturer. The laminated layers of plastic sheet include at least a first plastic sheet and a second plastic sheet. The first plastic sheet has a first tension stress of plastic property, i.e. modulus of elasticity, in a first direction and a lesser second tension stress of plastic property, i.e. modulus of elasticity, in a second direction. The second plastic sheet has a tension stress of plastic property in a first direction and a lesser tension stress of plastic property in a second direction that are the same as the first plastic sheet. When laminating the second sheet to the first sheet, an orientation is used where the first direction of the second sheet is perpendicular to the first direction of the first sheet. Once laminated, the oriented sheets form a laminate.

Graphics are provided on the laminate. The graphics can be printed onto the first plastic sheet, either before or after lamination.

A vacuum mold is provided, and the laminate is drawn into a form. The vacuum mold can contain the topographical features that the manufacturer would like to transfer to the surface of the globe. Excess flashing is trimmed away from each form to create a clean and straight equatorial edge. Each form is then inserted into an injection molding machine and a support plastic layer is molded against the concave surface of each form. This produces one hemisphere of the globe assembly. Two hemispheres are then joined to complete the globe assembly.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a partially fragmented front view of an exemplary embodiment of a globe assembly;

FIG. 2 is a perspective view of a laminate used to form part of the exemplary globe assembly of FIG. 1;

FIG. 3 shows an exploded view of the laminate shown in FIG. 2;

FIG. 4 shows a methodology progression of the laminate of FIG. 2 being formed in a vacuum mold;

FIG. 5 shows a methodology progression of the form of FIG. 4 being trimmed to create a trimmed form;

FIG. 6 shows a methodology progression of the trimmed form of FIG. 5 being enhanced in an injection molding machine to form a hemisphere;

FIG. 7 shows a methodology progression of two hemispheres being assembled to form the globe assembly of FIG. 1; and

FIG. 8 shows an alternate embodiment of hemispheres being formed into a globe assembly.

### DETAILED DESCRIPTION OF THE DRAWINGS

Although the present invention can be embodied in many ways, only two exemplary embodiments are illustrated. The exemplary embodiments are selected in order to set forth some of the best modes contemplated for the invention. The illustrated embodiments, however, are merely exemplary and should not be considered limitations when interpreting the scope of the appended claims.

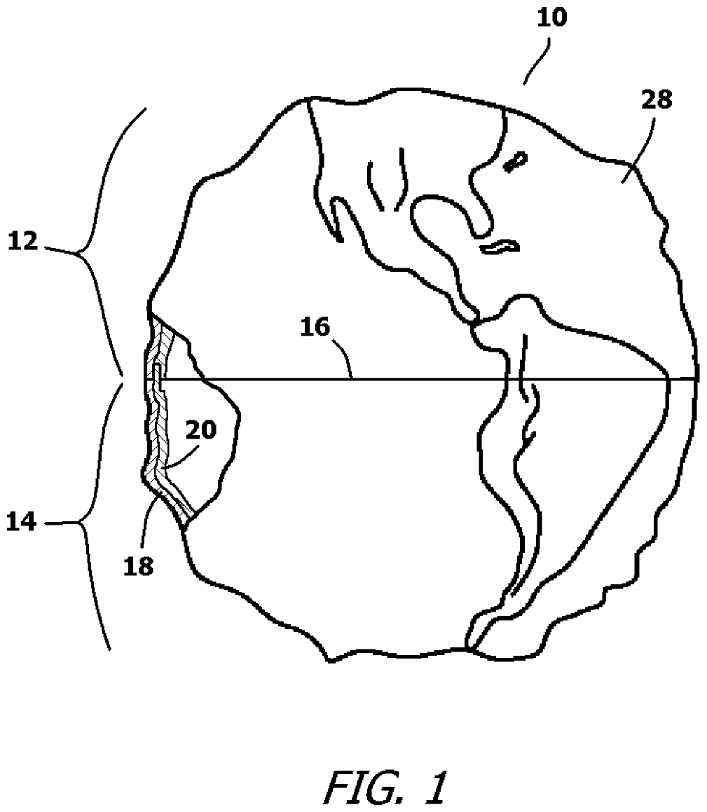

Referring to FIG. 1, a topographic globe assembly 10 is shown. The globe assembly 10 is configured as the earth. However, the globe assembly 10 can depict the moon, Mars, or any other celestial body, either real or imagined. The globe assembly 10 is made of two precision hemispheres 12, 14 that are joined along a common equatorial joint 16. The two hemispheres include a first hemisphere 12 and a second hemisphere 14. Both hemispheres 12, 14 have a multi-layer construction that is later explained in detail. The multi-layer construction includes a laminated exterior section 18 and a molded interior section 20, wherein the laminated exterior section 18 and the molded interior section 20 are bonded together.

The laminated exterior section 18 is made from at least two layers of polyvinyl chloride (PVC) sheeting. It will be understood in the art of plastic sheeting manufacture that hot virgin PVC is passed through a progression of calender rollers to form the PVC into sheets. The calender rollers provide the PVC sheets with a uniform selected thickness. As the PVC advances through the calender rollers, it experiences certain shear forces that affect the isotropic properties of the PVC sheet being produced. The shear forces imparted by the calender rollers alter the tension stress of plastic property, i.e. modulus of elasticity, embodied by the PVC as a function of orientation. The PVC passes through the calender rollers in a direction of travel that is perpendicular to the axis of the calender rollers. The tension stress of plastic property embodied in the sheets of PVC in this direction of travel is greater than the tension stress of plastic property in other directions, wherein the lowest tension stress of plastic property can be measured in the direction perpendicular to the direction of travel. For the purposes of this specification, the “high modulus” direction shall refer to the direction of travel through the calender rollers when the sheet of PVC is formed. Conversely, the “low modulus” direction shall be considered the direction that is perpendicular to the direction of travel.

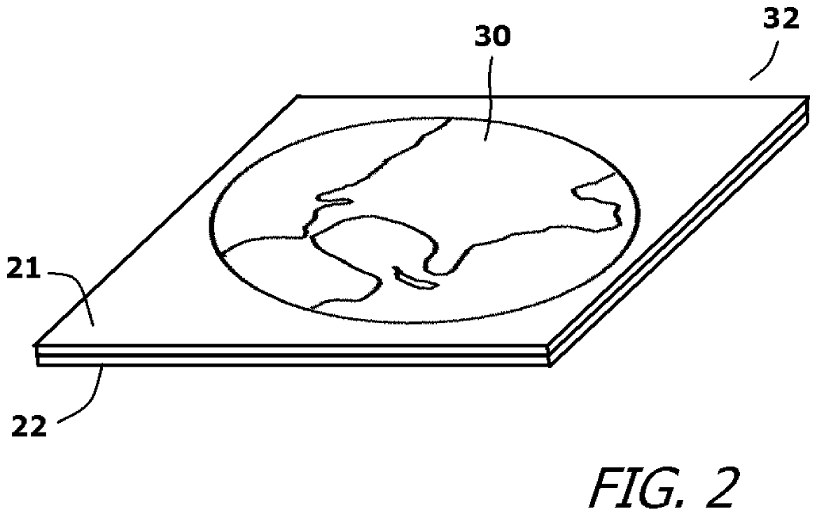

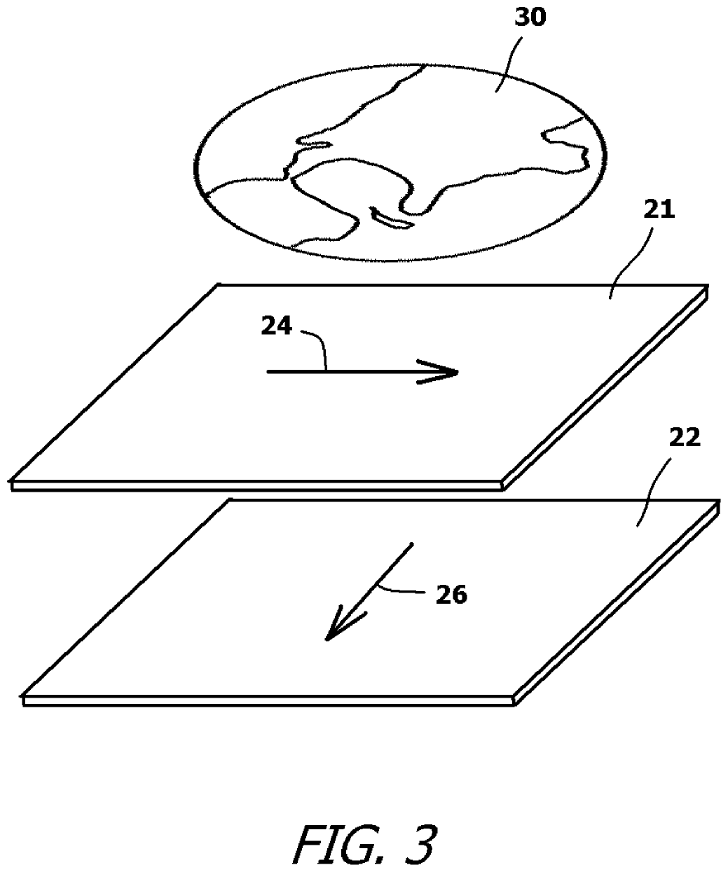

Referring to FIG. 2 and FIG. 3 in conjunction with FIG. 1, it will be understood that the laminated exterior section 18 of the globe assembly 10 begins as two or more PVC sheets 21, 22 that have been laminated together. The lamination can be achieved using heat, however, an adhesive is preferred. The PVC sheets 21, 22, therefore, contain at least a first PVC sheet 21 and one second PVC sheet 22. The first PVC sheet 21 and the second PVC sheet 22 are stacked in perpendicular orientations. That is, the first PVC sheet 21 is positioned with its high modulus direction in a first direction, as indicated by arrow 24. The second PVC sheet 22 is placed atop the first PVC sheet 21 with its high modulus direction turned perpendicular to the first direction, as is indicated by arrow 26. Subsequent sheets of PVC, if present, can be oriented at different angles, such as forty-five degrees offset from the first direction. What is of importance is that at least two of the PVC sheets have high modulus directions that are offset by ninety degrees.

The globe assembly 10 shown has raised topographical features 28. The topographical features 28 have a depth range that extends between a high point and a low point. The thickness and number of PVC sheets selected must be at least as thick, in combination, as the depth range of topographic features 28. In this manner all of the topographic features 28 can be embodied within the laminated exterior section 18. Graphics 30 are printed or applied to the top most of the PVC sheets. The printed and/or application of graphics 30 can occur either before or after lamination. In the preferred method of manufacture, the graphics 30 are applied using silk screen printing techniques. However, digital printers, stickers and even hand painting can also be used. The result is a flat laminate 32 with graphics 30 for half a globe. Since each flat laminate 32 only contains the graphics 30 for half a globe, it will be understood that two flat laminates 32 are created for each globe assembly 10, where each of the flat laminates 32 contains the graphics 30 for a different half of the globe assembly 10.

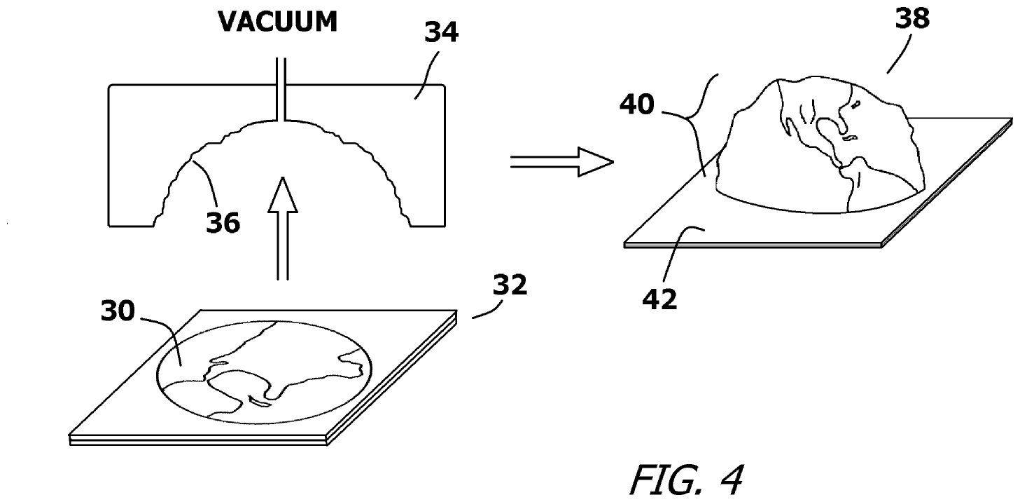

Referring to FIG. 4 in conjunction with FIG. 3 and FIG. 1, it will be understood that vacuum molds 34 are tooled, where in there is one for each hemisphere 12. 14 of the globe assembly 10. Each vacuum mold 34 contains a textured inner surface 36 that corresponds to the desired topographical features 28 to be contained on half the globe assembly 10. The flat laminate 32, printed with the proper graphics 30, is precisely placed into each of the vacuum molds 34. The flat laminates 32 are then heated above the yield temperature of the PVC. Vacuum is applied and the flat laminates 32 are drawn against the textured inner surface 36 of the vacuum molds 34. Since the PVC sheets 21, 22 in the flat laminates 32 are only heated slightly above yield temperature, there is no melting and very little warping of material and graphics 30 as the flat laminates 32 conform to the vacuum molds 34. The PVC is allowed to cool and is separated from the vacuum molds 34. The results are vacuum forms 38 that contain a hemispherical section 40 and a flash flange 42.

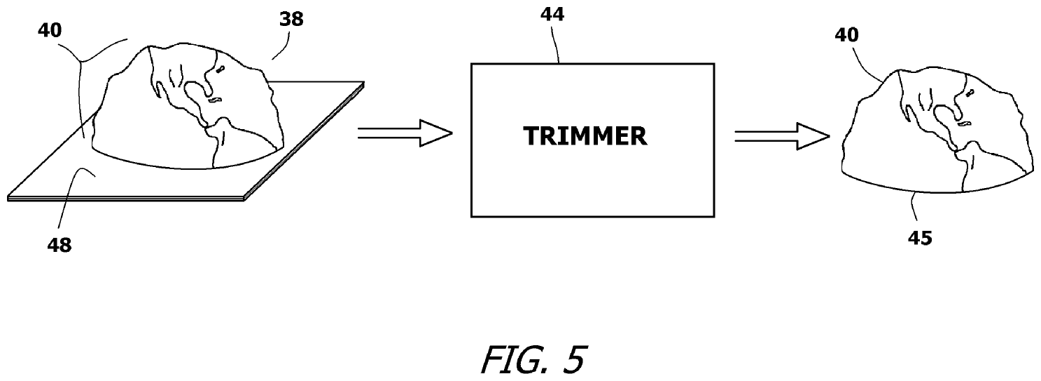

Referring to FIG. 5 in conjunction with FIG. 4, it will be understood that each vacuum form 38 is placed in a trimming machine 44 that precisely trims the hemispherical section 40 from the flash flange 42. Since the trimming machine 44 precisely trims the hemispherical sections 40, each hemispherical section 40 has a base edge 45 that is formed with precision.

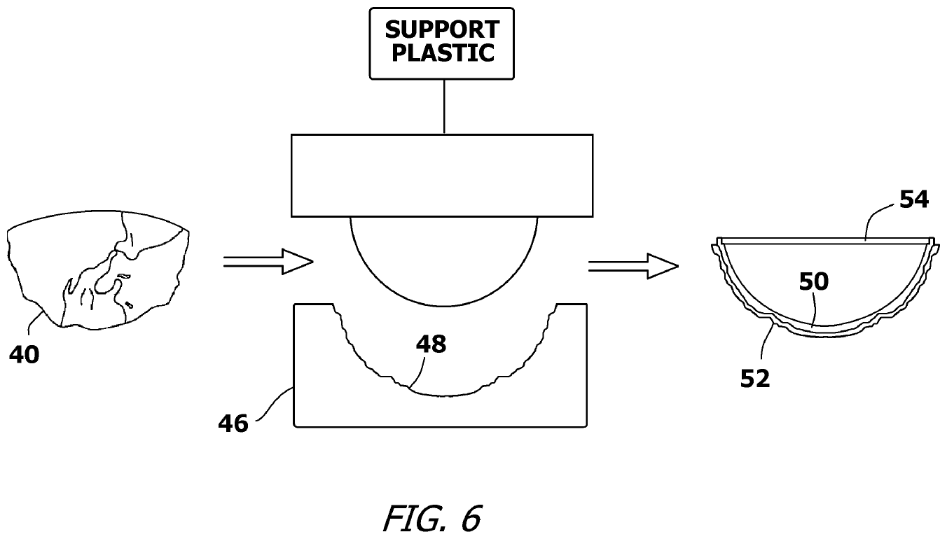

Referring to FIG. 6 in conjunction with FIG. 4 and FIG. 1, it can be seen that the trimmed hemispherical sections 40 are separately set into an injection mold 46. The injection mold 46 has a textured interior surface 48 that corresponds to that of the vacuum mold 34. In this manner, the features set by the vacuum mold 34 key into positions within the injection mold 46. This prevents the formed topographic features 28 from warping or otherwise changing when heated within the injection mold 46. The injection mold 46 injects a support plastic layer 50 onto the concave surface 52 of the trimmed hemispherical section 40. The thickness of the support plastic layer 50 is a matter of design choice and will vary given the diameter of the globe assembly 10. The material selected as the support plastic layer 50 can vary, provided it heat bonds to the trimmed hemispherical section 40. After injection molding, the first hemisphere 12 and the second hemisphere 14 are complete.

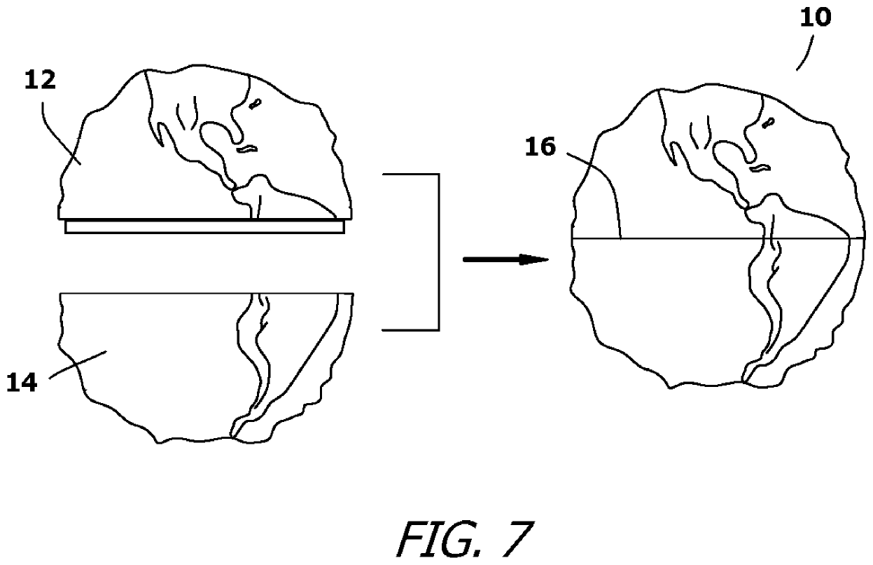

Referring to FIG. 7 in conjunction with FIG. 6 and FIG. 1, it will be understood that the support plastic layer 50 that is molded onto the concave surface 52 of each trimmed hemispherical section 40 can extend beyond, or into, the trimmed hemispherical sections 40. The extension can be used to create a connection collar 54 that enables the first hemisphere 12 and the second hemisphere 14 to interconnect with either a snap fit connection or a threaded connection.

The first hemisphere 12 and the second hemisphere 14 are joined together to form a completed globe assembly 10. Since the first hemisphere 12 and the second hemisphere 14 are precisely formed when trimmed, the two hemispheres close together precisely and form a smooth and accurate equatorial joint 16. The globe assembly 10 is complete and can be mounted in various globe holders.

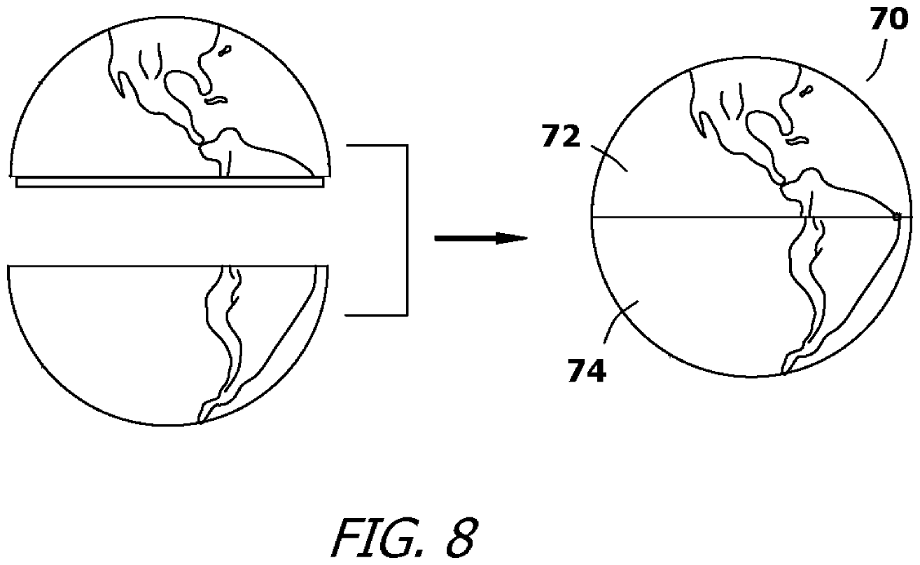

In the embodiment of FIG. 1 through FIG. 7, the methodology of forming a globe assembly 10 with raised topographical features 18 is described. It will be understood that the same methodology can be used to create a precision globe assembly that has a smooth exterior. Referring to FIG. 8, a globe assembly 70 is shown that has a smooth exterior surface 74. The globe assembly 70 is made using the manufacturing steps previously described. The only difference is that the surfaces used in the vacuum mold and the injection mold are smooth, rather than textured. Regardless, a globe assembly 70 is formed that has a precise equatorial joint 72.

It will be understood that the embodiments of the present invention that are illustrated and described are merely exemplary and that a person skilled in the art can make many variations to those embodiments. For instance, the diameter, thickness and topographical features of the globe can be altered as a matter of design choice. Likewise, the equatorial joint need not be along the equator of the globe assembly but can traverse the globe assembly along any longitudinal line. All such embodiments are intended to be included within the scope of the present invention as defined by the claims.

What is claimed is:

1. A globe assembly, comprising:
a laminated exterior section containing at least a first plastic sheet and a second plastic sheet, wherein both said first plastic sheet and said second plastic sheet have a first tension stress of plastic property in a longitudinal direction and a lesser second tension stress of plastic property in a traverse direction, and wherein said first plastic sheet is laminated to said second plastic sheet with said longitudinal direction of said first plastic sheet aligned with said traverse direction of said second plastic sheet; and
a plastic backing molded to said laminated exterior section within said globe assembly.

2. The globe assembly according to claim 1, wherein said laminated exterior section has an exterior surface, wherein raised topographical features are formed into said exterior surface.

3. The globe assembly according to claim 1, further including graphics applied to said laminated exterior section.

4. The globe assembly according to claim 1, wherein said laminated exterior section and said plastic backing of said globe assembly are formed into a first hemisphere and a second hemisphere that interconnect.

5. The globe assembly according to claim 4, wherein a connection collar is formed in said plastic backing that enables said first hemisphere and said second hemisphere to mechanically interconnect.

6. The globe assembly according to claim 1, wherein said first plastic sheet and said second plastic sheet are vacuum formed into said laminated exterior section.

7. The globe assembly according to claim 1, wherein said first plastic sheet and said second plastic sheet are identical sheets in perpendicular orientations.

8. A method of manufacturing a globe assembly, comprising:
providing a first plastic sheet and a second plastic sheet that both have a first tension stress of plastic property in a longitudinal direction and a lesser second tension stress of plastic property in a traverse direction;
printing graphics onto said first plastic sheet;
laminating said second plastic sheet to said first plastic sheet in an orientation where said longitudinal direction of said second plastic sheet is is aligned with said traverse direction of said first plastic sheet, therein forming a laminate;
vacuum forming said laminate into a form;
trimming said form to create a hemisphere;
molding a support plastic layer onto said hemisphere; and
joining said hemisphere to another said hemisphere to form a globe.

9. The method according to claim 8, wherein laminating said second plastic sheet to said first plastic sheet includes bonding said second plastic sheet to said first plastic sheet with an adhesive.

10. The method according to claim 8, wherein vacuum forming said laminate into a form includes providing a vacuum mold and drawing said laminate against a shaped surface of said vacuum mold.

11. The method according to claim 10, wherein said shaped surface is hemispherical and smooth.

12. The method according to claim 10, wherein said shaped surface is hemispherical and textured with topographical features, wherein said topographical features are transferred onto said form.

13. The method according to claim 8, wherein trimming said form creates an even edge on said hemisphere.

14. The method according to claim 8, wherein molding a support plastic layer onto said hemisphere includes placing said hemisphere into an injection molding machine and injecting said support plastic layer onto said hemisphere.

15. The method according to claim 14, wherein said injection molding machine creates a mechanical connector in said support plastic layer that enables one said hemisphere to be mechanically connected to another.

16. A method of manufacturing a globe assembly, comprising:
providing a first plastic sheet and a second plastic sheet;
laminating said second plastic sheet to said first plastic sheet form a laminate;
printing graphics into said laminate;
vacuum forming said laminate into a form;
trimming said form to create a hemisphere;
molding a support plastic layer onto said hemisphere; and
joining said hemisphere to another to form a globe.

17. The method according to claim 16, wherein both said first plastic sheet and said second plastic sheet have a first tension stress of plastic property in a longitudinal direction and a lesser second tension stress of plastic property in a traverse direction; and
wherein said second sheet is laminated to said first sheet in an orientation where said longitudinal direction of said second sheet is aligned with said traverse direction of said first sheet.

18. The method according to claim 17, wherein laminating said second sheet to said first sheet includes bonding said second sheet to said first sheet with an adhesive.

19. The method according to claim 17, wherein vacuum forming said laminate into a form includes providing a vacuum mold and drawing said laminate against a shaped surface of said vacuum mold, wherein said shaped surface is hemispherical and textured with topographical features, wherein said topographical features are transferred onto said form.

20. The method according to claim 16, wherein molding a support plastic layer onto said hemisphere includes placing said hemisphere into an injection molding machine and injecting said support plastic layer onto said hemisphere, wherein said injection molding machine creates a mechanical connector in said support plastic layer that enables one said hemisphere to be mechanically connected to another.
